(19) United States
(12) Patent Application Publication
(10) Pub. No.: US 2003/0196362 A1
(43) Pub. Date: Oct. 23, 2003

(54) System for displaying cards and memorabilia

(76) Inventor: Mark A. Harwell, Plano, TX (US)

Correspondence Address: THOMPSON & KNIGHT, L.L.P., PATENT PROSECUTION GROUP, 1700 PACIFIC AVENUE, SUITE 3300, DALLAS, TX, 75201, US

(21) Appl. No.: 10/124,951

(22) Filed: Apr. 18, 2002

(51) Int. Cl. G09F 3/18; A47G 1/06

(52) U.S. Cl. 40/661; 40/781

(57) ABSTRACT

A card display system for protecting and displaying a card, a grading label, and memorabilia is provided. Card display system includes a first shell member having a flange extending around a perimeter of first shell member and a second member having an inner surface and an outer surface. The inner surface of second shell member includes a card holding depression, a grading label depression, and a memorabilia depression. Second shell member is smaller than first shell member and the perimeter of second shell member is capable of engaging the flange of first shell member when the shell members are placed together.

### BACKGROUND OF THE INVENTION

1. Field of the Invention

This invention relates generally to a system and method for displaying and protecting collectable articles, and more particularly to a system and method for displaying and protecting cards, such as sports cards, and associated memorabilia.

2. Description of Related Art

Many people collect cards, such as sports cards, for pleasure or for investment. An important aspect of card collecting is the value of the cards. The economic laws of supply and demand are applicable to card collecting just as they are to any other field where a commodity is bought, sold, or traded in a free, unregulated market. Supply, which is the number of cards available on the market, is less than the total number of cards originally produced since attrition diminishes the original quantity. Each year, a percentage of cards is typically thrown away, destroyed, or otherwise lost to collectors. However, this percentage is much smaller today than it was in the past because more and more people have become increasingly aware of the value of their cards. The demand for cards is influenced by a number of primarily psychological factors such as the popularity of a particular player or team, and the general popularity of card collecting. Also, cards associated with a particular event, such as a superstar's rookie season, are in high demand.

Another factor in determining the value of a card is the card's condition. Other things being equal, the better the condition of a card, the higher its value. Grading standards vary among grading services, and condition grading is subjective. Although a particular grading service will typically apply the same standards to different cards, some leniency is given for older cards. An older card sometimes lacks the quality of a newer card because of technological limitations at the time the older card was manufactured. For example, an older card will often have edges that are not as crisp as those on newer cards, and the older card will sometimes have color inconsistencies in the displayed indicia. These differences are not necessarily the result of poor care for the older card, but may reflect a difference in cutting and printing technologies when the older card was manufactured.

The condition of cards is graded based primarily upon centering, corner wear, edge wear, and surface condition. Current centering terminology uses numbers representing the percentage of border on either side of the main design. A well centered card has substantially equal borders all the way around the card. Off centered cards range from slightly off center to badly off center. Corner wear is the most scrutinized grading criteria for cards. It is desired that the corners be sharp and completely unworn. One type of corner wear is a corner with a slight touch of wear showing. A more serious defect is a fuzzy corner, in which the corner still comes to a point, but the point has just begun to fray. Somewhat worse is a slightly rounded corner, in which the fraying of the corner has increased to the point that there is only a hint of a point.

Worse still is a rounded corner, in which the point is completely gone. Finally, a badly rounded corner is completely round and rough. Edge wear is similarly graded to reflect how clean and crisp the edges of the card appear.

A card defect related to surface condition is the crease. Creases can be categorized as to severity from light to medium to heavy. A light crease is a crease that is barely noticeable upon close inspection. A medium crease is noticeable when the card is held and steadied at arm's length with the naked eye; however, it does not overly detract from the appearance of the card. A heavy crease is one that has torn or broken through the card's picture surface.

In addition to the major criteria of centering, corner wear, edge wear, and surface condition, there are certain miscellaneous flaws that detract from the value of the card. For example, minor flaws such as bubbles or lumps in the surface, gum and wax stains, slanted borders, notching, off-center backs, paper wrinkles, scratched off cartoons or puzzles on the back of the card, rubber-band marks, scratches, surface impressions, and warping all tend to lower the card's grade. More serious flaws include chemical or sun fading, erasure marks, mildew, miscutting, holes, tape marks, tears, and stains.

It should be noted that grading services typically will not grade altered or counterfeit cards. Card owners sometimes attempt to “improve” a card by altering the card's appearance. Alterations to corners and edges could include trimming or retouching the corners and edges to hide wear. Surface alterations are sometimes attempted using ink or other dyes to improve the appearance of surface indicia. These alterations are almost always discovered and will disqualify a card from being graded.

Since almost any handling subjects a card to wear, there is a desire to place valuable cards in protective cases or containers. There is also a desire to provide a uniform system of grading or certification. In such a uniform system of certification, a card's condition is certified by a trusted expert grader. However, after a card has been graded, it is necessary that the card be protected from further wear. Additionally, it is necessary that the certification be permanently affixed to the protected graded card so that the grading cannot be altered or applied to another card.

There also is a desire to protect collectible memorabilia and to prevent or identify tampering with authenticated memorabilia. The collection of memorabilia commemorating a person, place, or event is similar in popularity to the collection of cards.

Many people collect and preserve memorabilia connected with sporting events that they attend or sporting figures that they admire. Examples of memorabilia could include pieces of uniforms or other clothing, programs or brochures associated with a sporting event, autographs of players, or equipment such as baseballs, bats, footballs, and the like. Display cases for items of memorabilia are well known. Because the authenticity of memorabilia is of great importance, some display cases provide ways to prevent or identify tampering with authenticated memorabilia.

The desirability of cards and memorabilia is sometimes enhanced by associating cards with related pieces of memorabilia. When cards and memorabilia are packaged together, the issues of card grading, memorabilia authentication, card protection, and prevention of tampering must all be addressed.

A need exists, therefore, for a system for displaying cards and memorabilia. A need also exists for a system that allows a grading label showing a card's “rated” condition to be secured with the card itself such that neither the grading label nor the card itself can be altered or manipulated. A need also exists for a system that allows an item of memorabilia to be secured with the card itself such that it cannot become disassociated with the card and such that it cannot be tampered with. Finally, a need exists for a system that preserves the card and the memorabilia and protects the items from moisture and additional wear.

### BRIEF SUMMARY OF THE INVENTION

The problems presented in displaying and preserving cards and memorabilia are solved by the systems of the present invention. In accordance with one embodiment of the present invention, a system for displaying cards and memorabilia is provided. The system includes a transparent first shell member and a transparent second shell member, each shell member having an inner surface, an outer surface, and a perimeter. The first shell member includes a flange extending around the perimeter. The second shell member is slightly smaller than the first shell member such that the flange of the first shell member is capable of matingly engaging the perimeter of the second shell member.

The card display system includes a card holding depression, a grading label depression, and a memorabilia depression, each of the depressions disposed on the inner surface of either the first shell member or the second shell member. Preferably, each of the depressions is spaced apart from the other depressions by a ridge.

Other objects, features, and advantages of the present invention will become apparent with reference to the drawings and detailed description that follow.

### BRIEF DESCRIPTION OF THE DRAWINGS

FIG. 1 illustrates a perspective, exploded view of a card display system according to the present invention, the card display system having a first shell member and a second shell member;

FIG. 2 depicts a sectional view of two card display systems stacked according to the present invention;

FIG. 3 depicts a front view of the card display system of FIG. 1;

FIG. 4 illustrates a rear view of the card display system of FIG. 1;

FIG. 5 depicts a sectional view of the second shell member of FIG. 1 taken at V-V;

FIG. 6 illustrates a sectional view of the second shell member of FIG. 1 taken at VI-VI; and

FIG. 7 depicts a sectional view of the second shell member of FIG. 1 taken at VII-VI.

### DETAILED DESCRIPTION OF THE PREFERRED EMBODIMENT

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical mechanical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

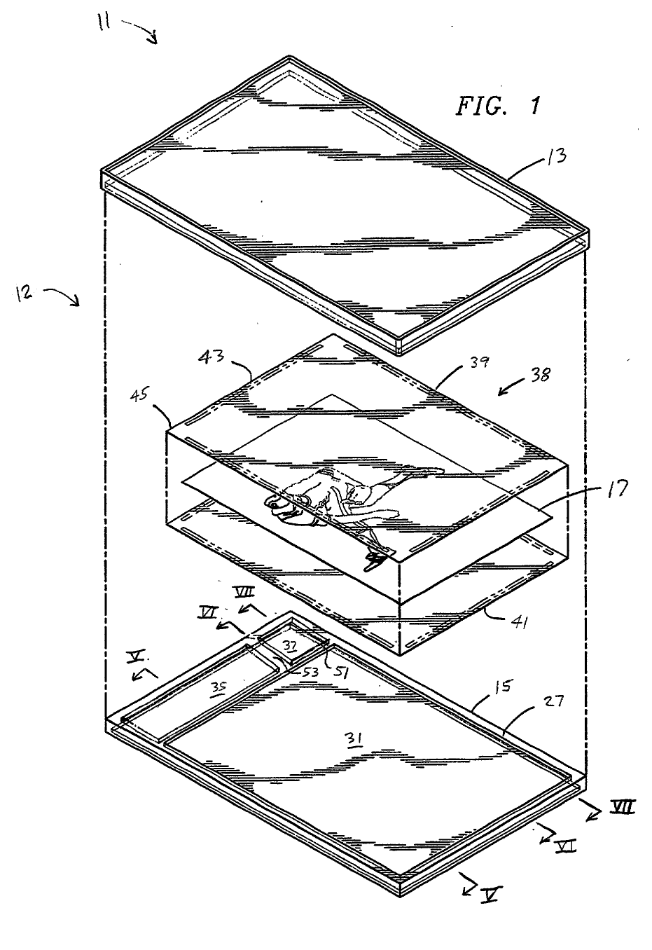

Referring to FIG. 1 in the drawings, a card display system 11 of the present invention includes a transparent case 12 having a first shell member 13 and a second shell member 15, and as will be explained in detail hereinafter, shell members 13 and 15 are sealingly engageable with each other to encase a card 17. Shell members 13 and 15 are preferably made of a substantially rigid transparent plastic such as polystyrene. In a typical embodiment, shell members 13 and 15 are each rectangular, but shell members 13 and 15 could be configured in any shape.

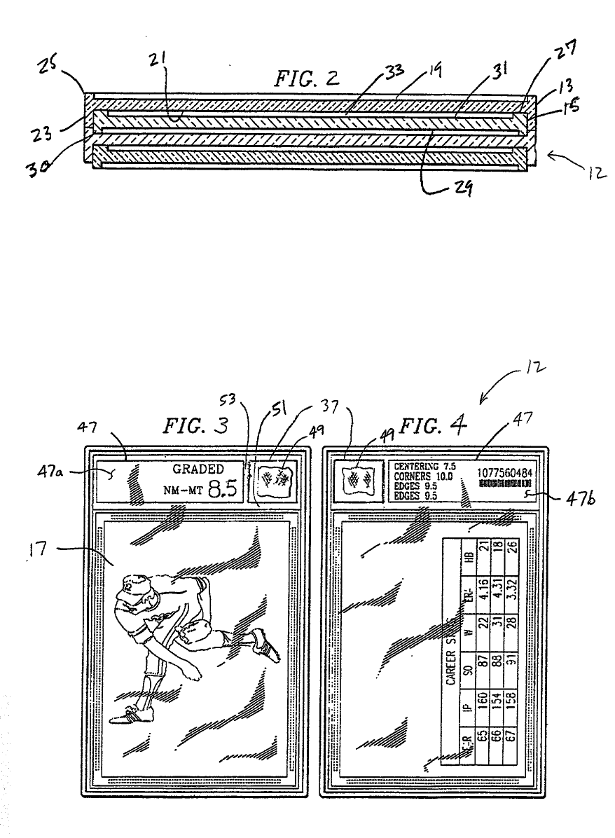

Referring to FIG. 2 in the drawings, first shell member 13 includes an outer surface 19 and an inner surface 21. The perimeter of first shell member 13 includes a first flange 23 that extends outwardly of inner surface 21. Preferably, the perimeter of first shell member 13 also includes a second flange 25 that extends outwardly of outer surface 19.

Second shell member 15 includes an inner surface 27 and an outer surface 29. Preferably, second shell member 15 is smaller than first shell member 13, and the perimeter of second shell member 15 is sized to matingly engage flange 23 of first shell member 13. The perimeter of second shell member 15 includes a flange 30 that extends outwardly of outer surface 29.

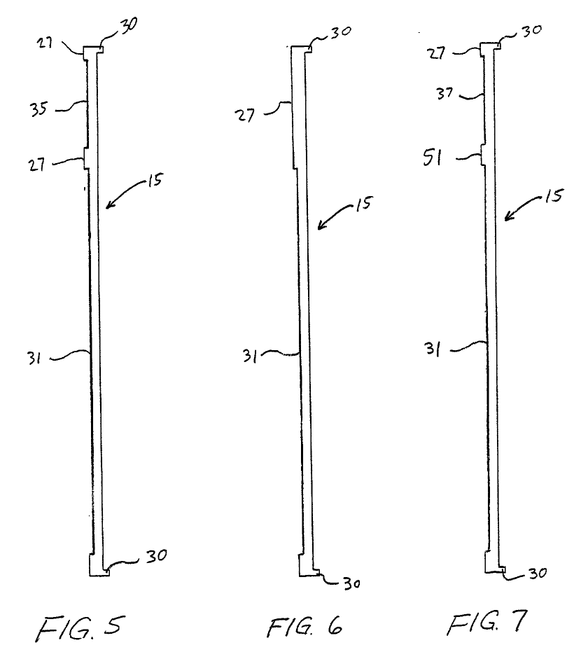

Referring still to FIG. 2 but also to FIGS. 1, 5, 6, and 7 in the drawings, inner surface 27 of second shell member 15 includes a card holding depression 31 positioned within the perimeter of second shell member 15. Because most collectible cards are rectangular, card holding depression 31 will typically be rectangular, but it could be configured in any shape. FIG. 2 illustrates first shell member 13 engaged with second shell member 15. When shell members 13 and 15 are engaged with each other, card holding depression 31 cooperates with inner surface 21 of first shell member 13 to form a card holding chamber 33. Inner surface 27 of second shell member 15 also includes a grading label depression 35, which is adapted to hold a grading label, and a memorabilia depression 37, which is adapted to hold a piece of memorabilia. A person having ordinary skill in the art will recognize that although depressions 31, 35, and 37 are shown disposed on inner surface 27 of second shell member 15, any or all of the depressions 31, 35, 37 could be disposed on inner surface 21 of first shell member 13.

Preferably, depressions 31, 35, and 37 are all located on inner surface 27 of second shell member 15, and each of the depressions is spaced apart from the other depressions on that surface 27. Inner surface 27 forms a first ridge 51 between memorabilia depression 37 and card holding depression 31. In the preferred embodiment, ridge 51 extends laterally to separate grading label depression 35 from card holding depression 31. A second ridge 53 separates memorabilia depression 37 from grading label depression 35. A person having ordinary skill in the art will recognize that the number and placement of the ridges separating the depressions 31, 35, and 37 will vary depending upon the placement of the depressions. It should also be noted that each ridge could extend past inner surface 27 (or another surface into which the depressions are disposed), which would have the effect of making the depressions deeper.

Card holding chamber 33 is adapted to receive a card, such as a sports card, when shell member 13 and 15 are engaged. In a preferred embodiment, sports card 17 would be placed directly into card holding chamber 33, however, card display system 11 could include a card holding sleeve 38 (see FIG. 1) that would provide additional protection to sports card 17. Card holding sleeve 38 has dimensions substantially the same as card holding depression 31 but larger than those of card 17. In some instances, the dimensions of card holding depression 31 may be slightly larger when a card holding sleeve 38 is used in order to accommodate both sleeve 38 and card 17.

Card holding sleeve 38 includes a first transparent sheet 39 and a second transparent sheet 41. Sheets 39 and 41 are preferably sheets of acid-free polypropylene with an ultraviolet (UV) protectant. Sheets 39 and 41 are adapted to be sealed around card 17. Of course, one of ordinary skill in the art will appreciate that sheets 39 and 41 may be formed by folding a single transparent sheet around card 17. If card holding sheets 39, 41 are used, it is preferred that sheets 39, 41 are sealed along central portions 43 of the edges of each sheet 39, 41, leaving corners 45 unsealed. Corners 45 are left unsealed to make the conditions of the corners of card 17 clearly visible and avoid the possibility of altering the condition of the corners. Card holding sleeve 38 can also prevent damage to card 17 by reducing movement within card holding chamber 33.

Referring to FIGS. 3 and 4 in the drawings, the operation of card display system 11 is illustrated. When a piece of memorabilia is to be associated with a card, both an expert grader and a person skilled in authenticating memorabilia are consulted. The expert grader applies established criteria to determine an overall grade for card 17, while the memorabilia authenticator can vouch for the authenticity of the piece of memorabilia. The certification service prepares a grading label 47, a front side 47a of which includes a numerical overall grade for the card and a descriptive condition. As shown in FIG. 3, card 17 has been awarded a numerical grade of 8.5 and a descriptive condition of near mint-mint, which indicates a card having only one minor flaw. A reverse side 47b of grading label 47 preferably includes detailed grades for centering, corners, and the like, as well as a certification number. Grading labels 47 may be color-coded according to the overall grade of the card. For cards manufactured between 1981 and the present (“modem” cards), cards graded 10 would have a gold grading label, cards graded 8 to 9.5 would have a silver grading label, and cards graded 7.5 or lower would have a white grading label. For cards manufactured prior to 1981 (“vintage” cards), cards graded 9.5 to 10 would have a gold grading label, cards graded 8.5 to 9 would have a silver grading label, cards graded 7 to 8 would have a bronze grading label, and cards graded 6.5 or lower would have a white grading label.

After card 17 has been graded, the card is placed into card holding depression 31 of second shell member 15. Grading label 47 is placed into grading label depression 35, and a piece of memorabilia 49 is then placed into memorabilia depression 37.

In another embodiment, card holding sleeve 38 is used, and card 17 is first placed between transparent sheets 39 and 41. The central portions 43 of the edges of sheets 39 and 41 are sonically sealed to form card holding sleeve 38 about card 17. Typically, in the embodiment where sheets 39 and 41 are rectangular in shape, the central portions 43 of up to three edges of sheets 39 and 41 may be sonically sealed together to form an envelope or slip cover prior to placing card 17 between sheets 39 and 41. Thereafter, the central portion 43 of the remaining edge or edges of sheets 39 and 41 may be sealed together. Alternatively, card 17 may be placed between sheets 39 and 41 before any of the central portions 43 of the edges of sheets 39 and 41 are sealed. After card 17 has been sealed within card holding sleeve 38, card 17 and sleeve 38 are placed into card holding depression 31. Grading label 47 is placed into grading label depression 35, and a piece of memorabilia 49 is then placed into memorabilia depression 37.

Memorabilia 49 could be any article commemorating or associated with a particular person (such as the person on card 17), a place, or an event. Some examples include, but are obviously not limited to, a piece of clothing from an athlete's uniform, a portion of a program from a sporting event, an autograph, a portion of a leather baseball cover, a lock of hair from a famous athlete, or a small amount of dirt from a renown sports field. One having skill in the art will recognize that this list is not exclusive and that memorabilia 49 could take many different forms. Preferably, memorabilia 49 has some connection to card 17, and preferably, memorabilia 49 is relatively flat in nature. While the depth of memorabilia depression 37 could vary, the preferred depth of memorabilia depression 37 will be approximately the same as the depth of grading label depression 35. It is of course conceivable that memorabilia depression 37 could be deepened significantly to accommodate bulky items of memorabilia such as pieces of sports equipment. Information about the piece of memorabilia 49 can be placed on grading label 17, on the back of a thin card (not shown) placed behind the piece of memorabilia 49, or on a card located in an additional depression (not shown).

After filling each depression 31, 35, 37 with its respective item, first shell member 13 is placed over second shell member 15 such that first flange 23 engages the perimeter of second shell member 15. Preferably, shell members 13 and 15 are then sonically welded together to permanently encase card 17, grading label 47, and memorabilia 49. One having skill in the art will recognize that the method of attaching first shell member 13 to second shell member 15 could vary and could include affixing the shell members 13, 15 with adhesive or by press fitting shell members 13, 15 together.

Referring again to FIG. 2 in the drawings, second flange 25 of first shell member 13 and flange 30 of second shell member 15 serve to protect the outer surfaces 19 and 29 of shell members 13 and 15, respectively. Flanges 25 and 30 serve as stand-offs to prevent contact of surfaces 19 and 29 with other surfaces, thereby preventing scratching or marring of the surfaces. Additionally, flanges 25, 30 provide a “stacking” capability when multiple card display systems are present. FIG. 2 illustrates two card display systems stacked such that flange 30 of second shell member 15 engages flange 25 of an adjacent card display system to prevent the card display systems from sliding relative to each other.

Even though many of the examples discussed herein are applications of the present invention having a transparent case with two independent shells, the present invention could also be embodied in a case having two shells that are hingedly attached to each other. Alternatively, two shells could be used that are independent of one another but that are capable of slidingly engaging each other before being placed into a “locked” or sealed position. Finally, it should be apparent that the present invention could be embodied in a transparent case of unitary construction. For such a case having only one piece, the case would likely contain a slot for receiving items into the card holding depression, the grading label depression, and the memorabilia depression.

From the foregoing, it will be recognized that the card display system of the present invention provides a superior system for protecting and displaying graded cards and memorabilia. The rigid transparent shell members prevent the card and memorabilia from moving and from being damaged after they have been encased. The seal between the shell members can be made to be tamper proof so that attempts to access the contents of the card display system can be detected.

It should be apparent from the foregoing that an invention having significant advantages has been provided. While the invention is shown in only a few of its forms, it is not just limited but is susceptible to various changes and modifications without departing from the spirit thereof.

We claim:

1. A card display system comprising:
a transparent case;
a card holding depression disposed within the transparent case;
a grading label depression disposed within the transparent case;
a memorabilia depression disposed within the transparent case; and
whereby each of the depressions is sealable such that items placed within the depressions are protected and secured.

2. The card display system according to claim 1, wherein:
the grading label depression is spaced apart from the card holding depression; and
the memorabilia depression is spaced apart from both the card holding depression and the grading label depression.

3. The card display system according to claim 1, wherein:
a first ridge separates the memorabilia depression from the card holding depression; and
a second ridge separates the memorabilia depression from the grading label depression.

4. The card display system according to claim 1 further comprising:
a transparent card holding sleeve having substantially the same dimensions as the card holding depression; and
wherein the card holding sleeve includes a first transparent sheet and a second transparent sheet, each of the sheets including edges having central portions and end portions, the first and second transparent sheets being attached at the central portions of the edges.

5. The card display system according to claim 1 further comprising:
a grading label having a grading label color;
a card grade disposed on the grading label, wherein said card grade is at least 0 and no more than 10; and
wherein said grading label is adapted to be held in the grading label depression.

6. The card display system according to claim 5, wherein the grading label color is used to indicate a particular card grade.

7. The card display system according to claim 1 further comprising a piece of memorabilia adapted to be received by the memorabilia depression.

8. A card display system comprising:
a transparent first shell member having an inner surface and an outer surface;
a transparent second shell member having an inner surface and an outer surface;
a card holding depression disposed in the inner surface of at least one of the first shell member and the second shell member;
a grading label depression disposed in the inner surface of at least one of the first shell member and the second shell member; and
a memorabilia depression disposed in the inner surface of at least one of the first shell member and the second shell member.

9. The card display system according to claim 8, wherein:
the grading label depression is spaced apart from the card holding depression; and
the memorabilia depression is spaced apart from both the card holding depression and the grading label depression.

10. The card display system according to claim 8, wherein:
a first ridge separates the memorabilia depression from the card holding depression; and
a second ridge separates the memorabilia depression from the grading label depression.

11. The card display system according to claim 8 further comprising:
a transparent card holding sleeve having substantially the same dimensions as the card holding depression; and
wherein the card holding sleeve includes a first transparent sheet and second transparent sheet, each of the sheets including edges having central portions and end portions, the first and second transparent sheets being attached at the central portions of the edges.

12. The card display system according to claim 8 further comprising:
a grading label having a grading label color;
a card grade disposed on the grading label, wherein said card grade is at least 0 and no more than 10; and
wherein said grading label is adapted to be held in the grading label depression.

13. The card display system according to claim 12, wherein the grading label color is used to indicate a particular card grade.

14. The card display system according to claim 8 further comprising a piece of memorabilia adapted to be received by the memorabilia depression.

15. The card display system according to claim 8, wherein the first shell member is sonically welded to the second shell member.

16. The card display system according to claim 8, wherein the second shell member is press fit into the first shell member.

17. The card display system according to claim 8, wherein the first shell member is secured to the second shell member using adhesive.

18. The card display system according to claim 8, wherein the first shell member and the second shell member are made of polystyrene.

19. A card display system comprising:
a transparent first shell member having an inner surface, an outer surface, and a flange extending around a perimeter of the first shell member;
a transparent second shell member having an inner surface, an outer surface, and a perimeter, the second shell member being smaller than the first shell member such that the flange of the first shell member matingly engages the perimeter of the second shell member;
a card holding depression disposed in the inner surface of at least one of the first shell member and the second shell member;
a grading label depression disposed in the inner surface of at least one of the first shell member and the second shell member;
a memorabilia depression disposed in the inner surface of at least one of the first shell member and the second shell member;
a first ridge separating the memorabilia depression from the card holding depression; and
a second ridge separating the memorabilia depression from the grading label depression.

20. The card display system according to claim 19 further comprising:
a transparent card holding sleeve having substantially the same dimensions as the card holding depression; and
wherein the card holding sleeve includes a first transparent sheet and second transparent sheet, each of the sheets including edges having central portions and end portions, the first and second transparent sheets being attached at the central portions of the edges.

21. The card display system according to claim 19 further comprising:
a grading label having a grading label color;
a card grade disposed on the grading label, wherein said card grade is at least 0 and no more than 10; and
wherein said grading label is adapted to be held in the grading label depression.

22. The card display system according to claim 21, wherein the grading label color is used to indicate a particular card grade.

23. The card display system according to claim 19 further comprising a piece of memorabilia adapted to be received by the memorabilia depression.

24. The card display system according to claim 19, wherein the first shell member is sonically welded to the second shell member.

25. The card display system according to claim 19, wherein the second shell member is press fit into the first shell member.

26. The card display system according to claim 19, wherein the first shell member is secured to the second shell member using adhesive.

27. The card display system according to claim 19, wherein the first shell member and the second shell member are made of polystyrene.
